(19) United States
(12) Patent Application Publication
(10) Pub. No.: US 2005/0196131 A1
(43) Pub. Date: Sep. 8, 2005

(54) Audio/video system and portable terminal therefor

(75) Inventors: Sadayuki Narusawa, Hamamatsu-shi (JP); Katsuaki Tanaka, Hamamatsu-shi (JP); Yasuhiro Matsunuma, Hamamatsu-shi (JP); Yasutaka Iwasaki, Hamamatsu-shi (JP)

Correspondence Address: PILLSBURY WINTHROP SHAW PITTMAN LLP, 725 S. FIGUEROA STREET, SUITE 2800, LOS ANGELES, CA, 90017, US

(73) Assignee: Yamaha Corporation, Hamamatsu-shi (JP)

(21) Appl. No.: 11/008,529

(22) Filed: Dec. 9, 2004

(30) Foreign Application Priority Data
Dec. 9, 2003 (JP) 2003-409952

(51) Int. Cl. H04N 5/76; H04N 5/781

(52) U.S. Cl. 386/46; 386/125

(57) ABSTRACT

Potable terminal includes a position detection section for identifying a room where a user is currently in, and a personal authentication section, such as a fingerprint sensor. In each room, there is provided an Audio/Video apparatus controlled by an Audio/Video-apparatus controlling manager. Information of user's entry or exit into or from any one of the rooms is transmitted wirelessly from the potable terminal, in response to which the Audio/Video-apparatus controlling manager performs ON/OFF control of the Audio/Video apparatus of the room, reproduction start/stop control of a music piece, etc. When the user has moved from one room to another, the manager performs control for reproducing, in the newly-moved-to room, a continuation of the music piece that was being reproduced in the previous room. In this way, the Audio/Video apparatus can be controlled in accordance with the user and position of the user.

### BACKGROUND OF THE INVENTION

The present invention relates to an Audio/Video (hereinafter abbreviated as “AV”) system which includes AV apparatus, such as audio reproduction apparatus, portable mobile terminals for controlling the AV apparatus, and a server apparatus that distributes audio data to the AV apparatus. The present invention also relates to portable terminal device for use in the AV systems.

Generally, various AV apparatus, such as television receivers, CD players, DVD players and audio reproduction apparatus, are controllable via remote control devices.

In order to allow the AV apparatus to perform operations corresponding to their respective users, remote control devices have been proposed which have a function of identifying a respective user of the AV apparatus (for example, Japanese Patent Application Laid-open Publication No. 2001-128253). With such a proposed remote control device, it is possible to identify the user using a fingerprint authenticator or the like, so that appropriate control corresponding to the identified user can be performed.

Also known today are audio data distribution systems each comprising a server apparatus storing a multiplicity of sets of music piece data, and audio reproduction apparatus (i.e., client apparatus) connected to the server apparatus via a communication network, such as a wired LAN or wireless LAN, and capable of reproducing each set of music piece data delivered from the server apparatus. With such an audio data distribution system, music piece data can be streamed (i.e., stream-distributed) to a plurality of client apparatus, located in a plurality of rooms within a building, and audibly reproduced via the client apparatus in each of the rooms; however, if the user has moved from one room to another within the building, the user can not enjoy listening to a continuation of the same music piece with no break (or blank period) without having to perform particular operation, and thus there is no choice but to simultaneously play the same music piece in all of the rooms. Therefore, the so-called “recall function” has been developed, which, even if some blank time period of music piece reproduction is involved, allows the user to enjoy listening to a continuation of the same music piece as listened to by the listener in the previous room.

The “recall function” is explained with reference to FIGS. 18 and 19. FIG. 18 is a block diagram showing an example hardware setup of a conventional audio distribution system, while FIG. 19 shows an example of a state management table stored in a server apparatus of the audio distribution system.

In FIG. 18, reference numeral 51 represents a server apparatus storing a plurality of sets of music piece data, 52 a communication network, and 53-55 first to third client apparatus (“Client 1” to “Client 3”) connected to the server apparatus 51 via the communication network 52. As shown, the client apparatus 53 to 55 are located in different rooms (i.e., Room 1-Room 3). Further, reference numeral 56 represents a remote control device (hereinafter referred to as “remote controller”) for controlling the individual client apparatus 53-55, and the remote controller 56 includes an infrared (IR) transmission section (IR transmitter) 57 that is capable of transmitting a control signal to an infrared (IR) reception section (IR receiver) built in each of the client apparatus 53-55. By controlling the individual client apparatus 53-55 through operation of the remote controller 56, the user can cause a desired music data set to be delivered from the server apparatus 51 and reproduced via the client apparatus 53-55.

The server apparatus 51 is provided with a management table storing respective states of the client apparatus 53-55. Each of the client apparatus 53-55 is constructed in such a manner that, whenever there has occurred a change in the states of the client apparatus or at predetermined time intervals, it transmits latest state information of the client apparatus to the server apparatus 51 via the communication network 52, so that the stored contents of the management table can be constantly maintained in updated, latest condition.

The management table of FIG. 19 indicates that the client apparatus 53-55 are in the following states. Namely, according to the management table, Client 1 is reproducing a third music piece in album A. More specifically, Client 1 is currently reproducing a “1:30”(“1 min. 30 sec.”) point of the third music piece; the value of the reproducing point is incremented by “1” per sec. as long as the reproduction of the music piece lasts. Further, in Client 1, two available reproduction modes, i.e. repeat reproduction mode and random reproduction mode, are each set in an OFF state. If the user does not perform any particular operation, fourth and fifth music pieces in album A will be automatically reproduced in sequence following the third music piece, and Client 1 will be shifted to a non-operating or stopped state after reproduction of the last music piece in album A.

Further, according to the management table of FIG. 19, Client 2 is currently in the non-operating or stopped state, and information indicating that the client apparatus terminated reproduction after having reproduced a second music piece of another album B up to a “2:10” point thereof is stored in the management table of the server apparatus 51. Further, the repeat reproduction mode is set at “Full Repeat”, while the random reproduction mode is set in the “OFF” state. Client 3 is currently in the stopped state, and no information about a last-reproduced music piece is stored in the management table; each client apparatus, which has not yet reproduced a music piece after purchase, assumes these states.

Let's now consider a case where a user, having so far been listening to a music piece (e.g., second music piece in album B) on Client 2 located in Room 2, moves from Room 2 over to Room 3 where Client 3 is located. In this case, the user first terminates the reproduction on Client 2 and then perhaps turns off, i.e. powers off, Client 2. The reproducing point when the reproduction is terminated is “2:10”, and thus the server apparatus 51 stores in the management table the information indicating that the client apparatus terminated the reproduction after having reproduced the second music piece of album B up to the “2:10” point, as illustrated in FIG. 19. Then, the user moves from Room 2 over to Room 3 where Client 3 is located, and manipulates Client 3 to perform an operation for recalling the states or operating conditions of Client 2. More specifically, the user either depresses a button “Recall Client 2” on the remote controller 56, or sequentially selects “Recall” and “Client 2” from a menu of the remote controller 56.

That such operation has been performed on Client 3 is immediately informed to the server apparatus 51. Because the server apparatus 51 knows that Client 2 was reproducing the second music piece of album B up to the “2:10” point immediately before the termination of the reproduction, it instructs Client 3 to reproduce the second music piece of album B from the “2:10” point onward, and it also instructs that the repeat reproduction mode be set to “Full Repeat” and the random reproduction mode be set in the “OFF” state. In this way, the states of Client 2 are copied to Client 3.

Where the user moves from Room 2 over to Room 3 without terminating the reproduction of Client 2, then the states of Client 2 when the user performed the recall operation via Client 3 are copied to Client 3. Let it be assumed that the user starts moving from Room 2 over to Room 3 without terminating the reproduction of Client 2 when Client 2 is reproducing the second music piece of album B up to the “2:10” point. In such a case, if the user arrives at ROOM 3 where Client 3 is located and performs the Client 2 recall operation via Client 3 30 sec. after exiting Room 2, Client 3 starts reproducing the second music piece of album B at a “2:40” point because, at that time, Client 2 is also reproducing the “2:40” point in Room 2. Note that states of each client, like Client 3 in the table of FIG. 19, currently set in the stopped state and having no previous reproduction-related information stored in the server apparatus, can not be recalled.

Further, Japanese Patent Application Laid-open Publication Nos. 2002-328949 and HEI-11-146426 disclose a technique of associating a listening environment of audio data, such as digital content, with user's movement.

However, although the conventional remote controllers, having the function of identifying an individual, can perform apparatus control corresponding to the user by identifying who the user is, they can not provide and appropriately manage specific user-position information as to which room the user is currently in. Further, with the conventional techniques, it is necessary for the user to perform the control of the apparatus in a manual manner, which would result in various inconveniences; for example, the user tends to forget to power off the apparatus.

Furthermore, when the user temporarily leaves or exits the room during the course of reproduction of a music piece, the user has to perform operation for intentionally stopping or temporarily stopping (or interrupting) the reproduction. If, in such a case, the user forgets to perform the interrupting or stopping operation, then the reproduction of the music piece will have progressed a considerable amount, which thus necessitates the user to return the reproduction to the position which the user was listening to immediately before exiting the room.

Furthermore, in order to allow the user to enjoy listening to a continuation, without a break or blank period, of the music piece which was being listened to in the previous room after exiting that room, the same music piece has to be kept playing simultaneously in every one of the room irrespective of whether or not the user is in the room. Even in this case, there would occur a break (blank time period) in the reproduced music piece that corresponds to a time length of the user's movement.

Furthermore, even where the above-mentioned recall function is used, the user, having moved from one room to another, has to perform operation for calling up the same music piece through manipulation of the audio apparatus located in the other or newly-moved-to room. Moreover, if the music piece to be reproduced is limited in the number of permissible simultaneous reproduction, then the user may not be allowed to listen to the same music piece any longer after exiting the room.

### SUMMARY OF THE INVENTION

In view of the foregoing, it is an object of the present invention to provide an AV system and portable terminal for the AV system which can automatically control powering-ON/OFF of AV apparatus and reproduction of a music piece on the AV apparatus.

It is another object of the present invention to provide an AV system which, when the user has moved from one room to another or re-entered a same room, allows the user to enjoy listening to a continuation of the same music piece that was being listened to by the user immediately before the movement or re-entry.

It is still another object of the present invention to provide an AV system which, even when the user has exited one room where a music piece, limited in the number of permissible simultaneous reproduction, is being reproduced, allows the user to enjoy listening to the same music piece in another or newly-moved-to room.

In order to accomplish the above-mentioned objects, the present invention provides an AV system comprising AV apparatus, an AV-apparatus management apparatus that controls the AV apparatus, and a portable terminal. In the AV system of the present invention, the portable terminal includes a personal authentication section and a position detection section, and the AV-apparatus management apparatus includes a section that stores personal information and position information of each user. On the basis of personal authentication information and position detection information transmitted by the portable terminal, the AV-apparatus management apparatus performs control to power on the AV apparatus located in a room upon detecting that the user has entered the room, or performs control to place the AV apparatus located in a room in a standby state (in this case, power-OFF state) upon detecting that the user has exited the room.

The present invention also provides an AV system comprising AV apparatus, an AV-apparatus management apparatus that controls the AV apparatus, and a portable terminal, in which the portable terminal includes a personal authentication section and a position detection section, and the AV-apparatus management apparatus includes a section that stores personal information and position information of each user and, on the basis of personal authentication information and position detection information transmitted by the portable terminal, performs control to power on the AV apparatus located in a room upon detecting that the user has entered the room and thereby cause the AV apparatus in the room to reproduce a music piece corresponding to the user. Upon detecting that the user has exited a room while the AV apparatus located in the room is reproducing a music piece, the AV-apparatus management apparatus performs control to place reproduction of the music piece in a temporarily stopped state and then place the AV apparatus located in the room in a standby state (in this case, power-OFF state) when the temporarily stopped state has lasted for a predetermined time.

In an embodiment of the present invention, upon detecting that the user has re-entered a room while the AV apparatus located in the room is in the temporarily stopped state, the AV-apparatus management apparatus causes the AV apparatus in the room to resume reproduction of a music piece having so far been temporarily stopped.

In an embodiment of the present invention, when the reproduction of the music piece is to be placed in the temporarily stopped state in response to detection of the user exiting the room, the AV-apparatus management apparatus performs a fade-out operation on the music piece and then places the AV apparatus of the room in the standby state.

In an embodiment of the present invention, when the reproduction of the music piece corresponding to the user is to be initiated in response to detection of the user entering the room, the AV-apparatus management apparatus performs a fade-in operation on the music piece.

The present invention also provides an AV system comprising AV apparatus, an AV-apparatus management apparatus that controls the AV apparatus, and a portable terminal. In the inventive AV system, the AV apparatus includes a section that reproduces music piece data supplied by the AV-apparatus management apparatus, the portable terminal includes a personal authentication section and a position detection section, and the AV-apparatus management apparatus includes a section that stores a plurality of sets of music piece data, and a section that stores personal information and position information of each user. On the basis of personal authentication information and position detection information transmitted by the portable terminal, the AV-apparatus management apparatus performs, upon detecting that the user has exited one room, a fade-out operation on a music piece, which is being currently reproduced in the one room, to thereby stop reproduction of the music piece in the one room, and then, upon detecting that the user has entered another room, causes the AV apparatus in the other room to resume the reproduction of the music piece by performing a fade-in operation on the music piece with reproducing states in the one room copied to the other room.

In one embodiment of the invention, the time point at which the reproduction of the music piece should return to a normal reproduction level in the fade-in operation is set at a given time point that precedes an attenuation start time point in the fade-out operation.

In one embodiment of the invention, parameters for the fade-in and fade-out operations are variably set in accordance with a moving speed of the user and genre of the music piece, so as to secure auditorily-natural continuity of the reproduced music piece.

In one embodiment of the invention, when the music piece is one that is limited in the number of permissible simultaneous reproduction, control is performed such that the right to reproduce the music piece is transferred from the room which the user exited over to the room which the user has entered.

In one embodiment of the invention, the portable terminal includes: the personal authentication section with a fingerprint sensor that acquires user-authentication-related information; the position detection section that receives, from a transmitter, a signal identifying a room where the AV apparatus is located; and a section that transmits, to the AV-apparatus management apparatus, personal authentication information acquired by the personal authentication section and position detection information acquired by the position detection section.

In one embodiment of the invention, the portable terminal includes a section that sets a personal ID of the user; an operation button operable when the user has entered or exited a room where the AV apparatus is located, and a section that transmits, to the AV apparatus, information indicating that the operation button has been operated and the personal ID of the user, and the personal authentication information and the position detection information is transmitted via the AV apparatus to the AV-apparatus management apparatus.

According to another aspect of the present invention, there is also provided a portable terminal for use in an AV system comprising AV apparatus and an AV-apparatus management apparatus including a section that stores personal information and position information of each user, the AV-apparatus management apparatus controlling the AV apparatus in response to entry or exit, to or from a room, of the user. In the invention, the portable terminal includes: a reception section that receives a signal from an infrared transmitter provided, in a room where the AV apparatus is located, for transmitting a signal identifying the room; a fingerprint sensor; and a section that transmits, to the AV-apparatus management apparatus, user-authentication-related information acquired by the fingerprint sensor and room-related information acquired by the reception section.

In the AV system of the present invention, the personal authentication and position detection of the user can be executed via the portable terminal. Also, in the present invention, the AV apparatus can be automatically powered on when the user has entered the room where the AV apparatus is located, and the AV apparatus can be automatically placed in the standby state (in this case, power-OFF state). Thus, the user does not have to perform particular operation for powering on (i.e., turning on the power supply to) the AV apparatus, and the AV apparatus can be reliably prevented from being inadvertently left in the power-ON state.

Further, when the user has exited the room during reproduction of a music piece, the present invention can automatically temporarily stop or interrupt the reproduction of the present invention. When the user has re-entered the same room within a predetermined time, a continuation of the music piece can be automatically reproduced in the room. If the temporarily-stopped (or interrupted) state lasts for more than the predetermined time, the AV apparatus is automatically placed in the standby (i.e., power-OFF) state; therefore, the AV apparatus can be prevented from being inadvertently left in a sounding state. Also, when the user has re-entered the room, the same states of the AV apparatus as when the user exited the room are automatically resumed, which eliminates a need for the user to perform particular operation after the re-entry into the room.

Further, when the user has moved from one room to another during reproduction of a music piece in the one (i.e., previous) room, a continuation of the music piece can be automatically reproduced in the other (i.e., newly-moved-to) room, via the AV apparatus of the other room, by the user merely performing minimum necessary operation. At that time, not only the music piece but also a setting of a reproduction mode, such as a random or repeat reproduction mode, can be taken or copied over to the new room. Therefore, in the present invention, the same states as in the previous room can be set in the new room without the user performing any particular operation, or by the user just performing very simple operation.

Furthermore, when the user exits a room, a music piece being reproduced in the room is subjected to a fade-out operation to gradually shift to a temporarily-stopped (i.e., interrupted) state, and, when the user enters a room, the reproduction of the music piece is resumed in a fade-in fashion; thus, the present invention permits smooth tone deadening (silencing) and smooth start of tone generation.

Moreover, because the time point at which the reproduction of the music piece should return to the normal reproduction level in the fade-in operation in the newly-moved-to room is set at a time point that precedes the attenuation start time point in the fade-out operation in the previous room, the present invention can achieve natural musical connection without involving a break or blank time in the music piece.

Furthermore, because the present invention allows the right to reproduce a music piece to be automatically transferred between the AV apparatus, even a music piece limited in the number of permissible simultaneous reproduction can be reproduced appropriately without requiring particular user operation.

The following will describe embodiments of the present invention, but it should be appreciated that the present invention is not limited to the described embodiments and various modifications of the invention are possible without departing from the basic principles. The scope of the present invention is therefore to be determined solely by the appended claims.

### BRIEF DESCRIPTION OF THE DRAWINGS

For better understanding of the object and other features of the present invention, its preferred embodiments will be described hereinbelow in greater detail with reference to the accompanying drawings, in which:

FIG. 1 is a block diagram showing an example general setup of an AV system in accordance with a first embodiment;

FIG. 2 is a block diagram showing an example general setup of a portable terminal employed in the AV system of FIG. 1;

FIG. 3 is a block diagram showing principal sections of an AV-apparatus controlling manager employed in the AV system of FIG. 1;

FIGS. 4A-4B are diagrams showing examples of a personal information management table, AV apparatus information management table and AV-apparatus-control and entry/exit-process management table;

FIG. 5 is a flow chart showing an example operational sequence of a personal authentication process performed in the first embodiment;

FIG. 6 is a flow chart showing an example operational sequence of a room entry process performed in the first embodiment;

FIG. 7 is a flow chart showing an example operational sequence of a room exit process performed in the first embodiment;

FIGS. 8A and 8B are diagrams respectively showing examples of an AV apparatus management table and user management table performed in the first embodiment;

FIG. 9 is a flow chart showing an example operational sequence of a room exit process performed in the second embodiment;

FIG. 10 is a flow chart showing an example operational sequence of a room entry process performed in the second embodiment;

FIGS. 11A and 11B are diagrams respectively showing examples of an AV apparatus management table and user management table performed in the second embodiment;

FIGS. 12A and 12B are diagrams respectively showing the AV apparatus management table and user management table having been updated from the states of FIGS. 11A and 11B;

FIGS. 13A and 13B are diagrams respectively showing the AV apparatus management table and user management table having been updated from the states of FIGS. 12A and 12B;

FIGS. 14A and 14B are diagrams respectively the AV apparatus management table and user management table having been updated from the states of FIGS. 13A and 13B;

FIG. 15 is a block diagram showing an example general setup of a third embodiment of the present invention;

FIG. 16 is a flow chart showing an example operational sequence of a room entry process performed in the third embodiment;

FIG. 17 is a flow chart showing an example operational sequence of a room exit process performed in the third embodiment;

FIG. 18 is a block diagram showing an example general setup of a conventional audio distribution system; and

FIG. 19 is a diagram showing an example of a state management table stored in a server apparatus of the conventional audio distribution system of FIG. 18.

### DETAILED DESCRIPTION OF THE INVENTION

[Embodiment 1]

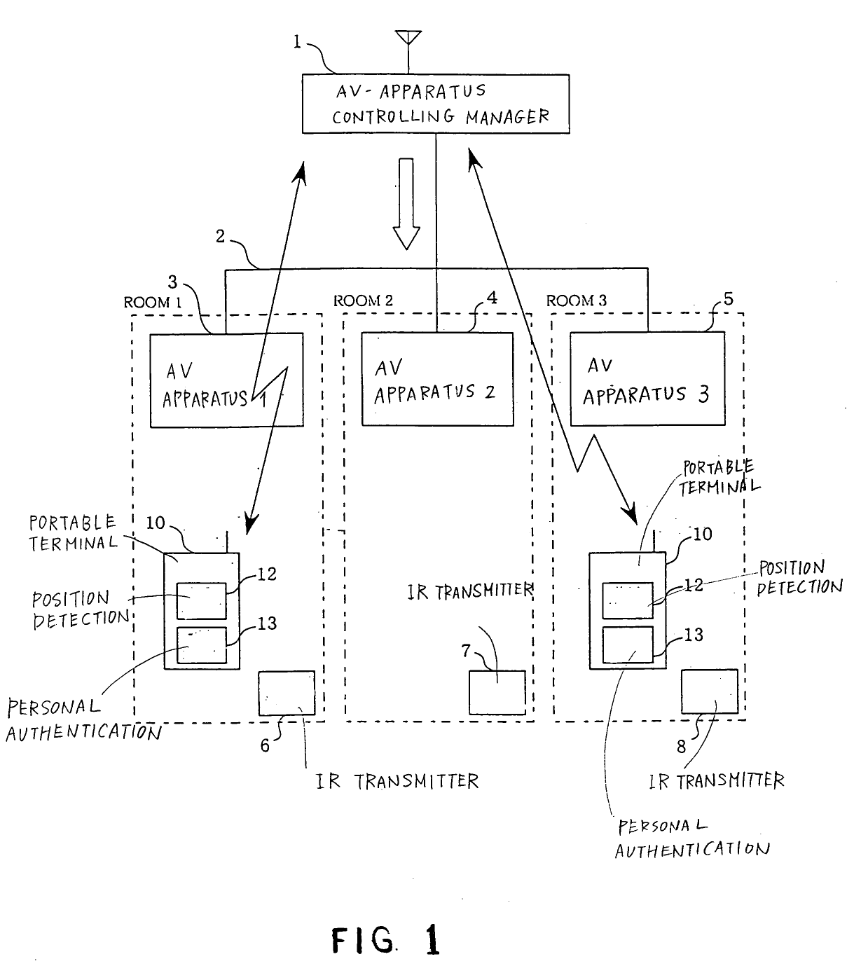

FIG. 1 is a block diagram showing an example general setup of an AV (Audio-Visual) system in accordance with a first embodiment of the present invention. The AV system of FIG. 1 includes an AV-apparatus controlling manager 1 for controlling AV apparatus, a communication network 2, such as a wired LAN or wireless LAN, and a plurality of AV apparatus 3, 4 and 5 connected to the communication network 2 for control or management by the AV-apparatus controlling manager 1. Here, the AV apparatus 3, 4 and 5 are located within different rooms (Room 1, Room 2 and Room 3), and these AV apparatus may each be any one of a television receiver, CD player, DVD player, audio reproduction apparatus and client apparatus of an audio distribution system as long as the AV apparatus have a function of reproducing audio signals of music pieces etc.

Further, in the figure, reference numerals 6, 7 and 8 represent infrared (IR) transmitters located in Room 1, Room 2 and Room 3, respectively, for transmitting infrared signals modulated with room identification codes corresponding to the rooms.

Portable terminals (mobile controllers) 10 are provided in the rooms for controlling the corresponding AV apparatus. As shown, each of the portable terminals 10 includes: a position detection section 12 for receiving the infrared signals, including the room identification codes, transmitted from the IR transmitters 6-8; an personal authentication section 13 for identifying a user operating the portable terminal; and a wireless communication section for transmitting, to the AV-apparatus controlling manager 1, results of detection by the position detection section 12 and personal authentication section 13.

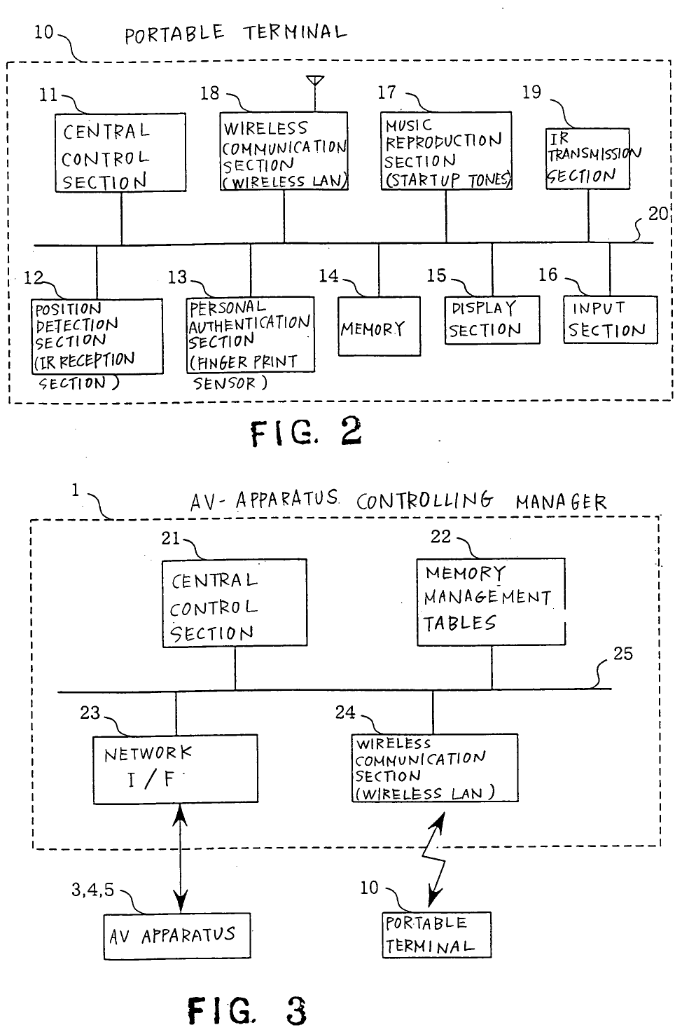

FIG. 2 is a block diagram showing an example general setup of the portable terminal 10, which includes a central control section 11 for controlling the portable terminal 10 and the position detection section 12 for detecting a current position of the portable terminal 10. The position detection section 12 is, for example, an infrared receiver for receiving the room identification codes transmitted from the IR transmitters 6-8. The portable terminal 10 also includes the personal authentication section 13 for detecting who the user operating the portable terminal 10 is, and it is, for example, a fingerprint sensor. Further, in the figure, reference numeral 14 represents a memory functioning as storage areas for storing control programs of the central control section 11, personal information of the user detected by the personal authentication section 13 and various other data, and also as working areas for the central control section 11. Further, reference 15 represents a display section, 16 an input section, 17 a music reproduction section for generating predetermined startup tones, 18 a wireless communication section for transmitting personal authentication data and position detection data to the AV-apparatus controlling manager 1 and receiving control signals etc. from the AV-apparatus controlling manager 1, 19 an infrared transmission section (IR transmitter) for transmitting various control signals to the AV apparatus 3-5, and 20 a bus via which various data are transferred between the various components of the portable terminal 10.

For example, the AV system of the present invention is intended for domestic (household) use, and a plurality of the portable terminals 10 are provided in the house. As noted above, each of the portable terminals 10 includes the personal authentication section 13, so that the personal authentication is permitted via each of the apparatus. Thus, in this case, which portable terminals should belong to which persons is not particularly fixed. As will be later described in detail, once the personal authentication section (fingerprint sensor) 13 of any one of the portable terminals 10 has identified the user holding the portable terminal 10 in his or her hand, a skin (i.e., file storing information related to an appearance of application software) set previously by the identified user is selected, and a GUI (Graphical User Interface) dedicated to the identified user is visually displayed on the display section 15. Also, startup tones registered previously by the identified user are audibly generated by the music reproduction section 17.

FIG. 3 is a block diagram showing principal sections of the AV-apparatus controlling manager 1. The controlling manager 1 includes a central control section 21 for controlling the entire manager 1, a memory 22, a network interface section 23 for connection with the AV apparatus 3, 4 and 5, a wireless communication section 24 for connection with the portable terminals 10, and a bus 25 via which various data are transferred between the various components of the controlling manager 1.

Here, the memory 22 of the AV-apparatus controlling manager 1 contains, in addition to control programs for execution by the central control section 21 and various data, various management tables, such as (a) a personal information management table storing information about one or more registered users, (b) an AV apparatus information management table storing states of the users and AV apparatus, and (c) an AV-apparatus-control and entry/exit-process management table storing processes performed when any one of the users has entered/exited one of the rooms.

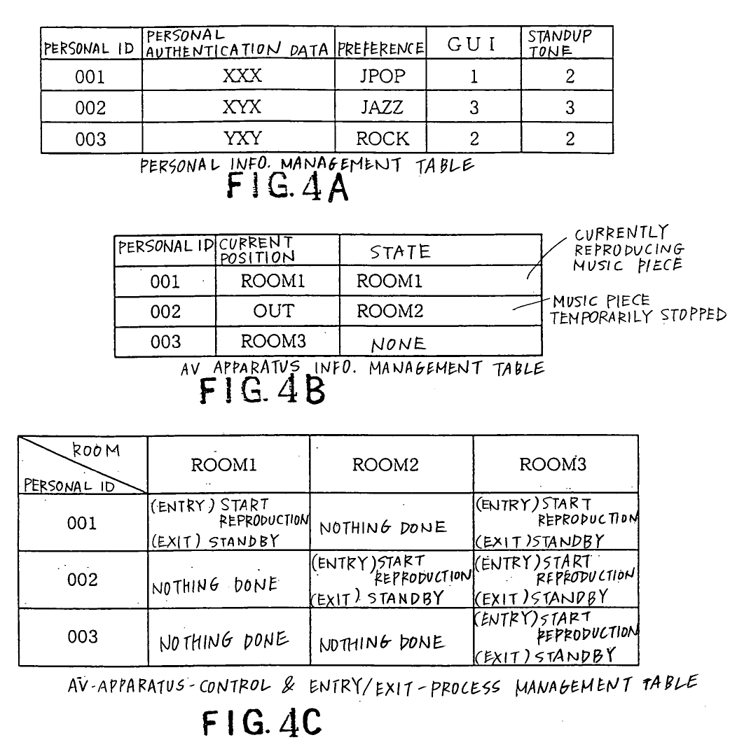

FIGS. 4A-4B show examples of the above-mentioned management tables. Namely, FIG. 4A shows an example of the personal information management table, in which are stored, for each of the users, authentication data of the user, music (or music piece) preference of the user and unique numbers indicative of a desired GUI and startup tones selected by the user. When the user uses the portable terminal 10 for the first time, such authentication data, music preference and desired GUI and startup tones of the user can be registered, e.g. during initial registration. The user can change the registered contents at any desired time.

FIG. 4B shows an example of the AV apparatus information management table, in which are stored respective positions of the users and respective states of the rooms. As noted earlier, each of the portable terminals 10 has previously detected and informed, via wireless communication, the AV-apparatus controlling manager 1 of the position of the terminal 10 (i.e., information as to which of the rooms the terminal 10 is located in, or information that the terminal 10 is not located in any one of the rooms) detected by the position detection section 12, and each of the AV apparatus has previously informed, via the communication network, the AV-apparatus controlling manager 1 of its operating states. This AV apparatus information management table is updated each time there has occurred a change in the states, e.g. each time the duly-authenticated user holding the portable terminal 10 has entered or exited any one of the rooms. Let's assume here that one AV apparatus is located in each of the rooms (Room 1-Room 3).

Further, FIG. 4C shows an example of the AV-apparatus-control and entry/exit-process management table, in which are stored, for each of the users and rooms, processes to be performed on the AV apparatus when the user has entered and exited the room. This management table is set up during the initial registration, and the registered contents of the table can be changed at any desired time.

In the system thus arranged, each of the users can enter, with the portable terminal 10, any one of the rooms (Room 1-Room 3) where the AV apparatus 3-5 are located, and cause the AV apparatus, located in the room, to reproduce a desired music piece by manipulating the portable terminal 10. Because the portable terminal 10 is provided with the position detection section 12, personal authentication section 13 and wireless communication section as noted above, the AV-apparatus controlling manager 1 can obtain information as to which of the users has entered which of the rooms, and thereby automatically perform a process for, for example, powering on the corresponding AV apparatus and other processes for reproducing a music piece corresponding to the user and setting an environment of the portable terminal corresponding to the user.

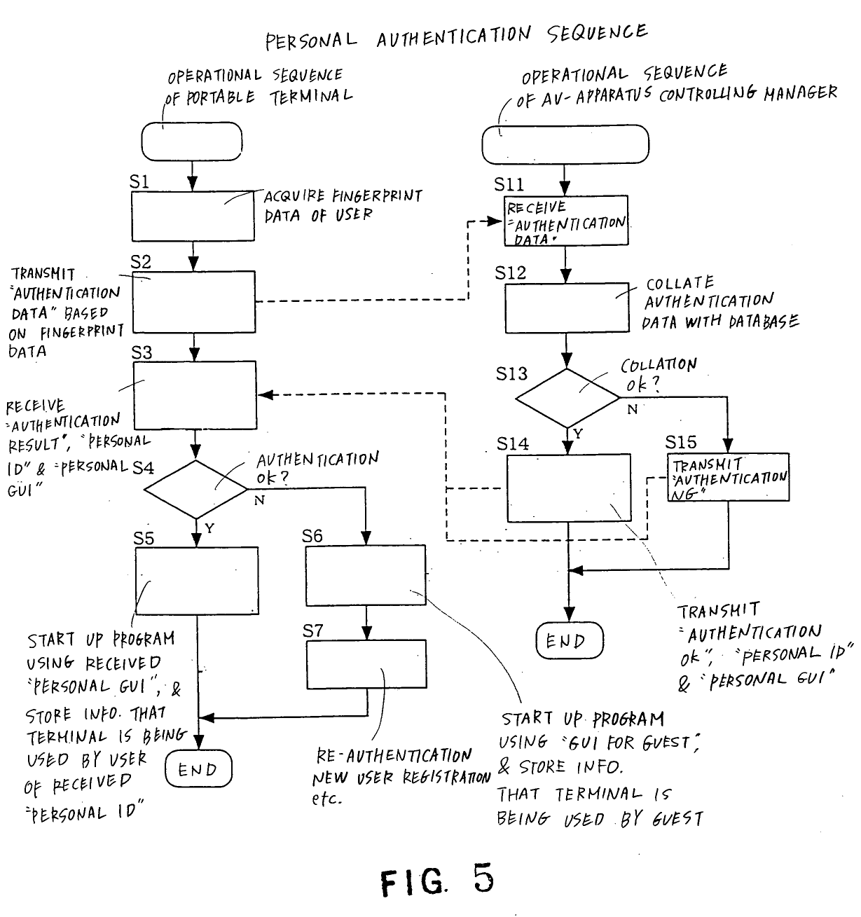

FIG. 5 is a flow chart showing an example operational sequence of a personal authentication process (or personal authentication sequence) to be first carried out as any one of the users picks up a desired one of the portable terminals 10 and starts manipulating the portable terminals 10.

Once the user holding the portable terminals 10 puts his or her finger on the fingerprint sensor section 13 to cause the sensor section 13 to read the fingerprint of the user, fingerprint data is acquired at step S1, and authentication data (characteristic data of the user) is generated and transmitted to the AV-apparatus controlling manager 1 at step S2.

Then, the AV-apparatus controlling manager 1 receives the authentication data at step S11, and collates the received authentication data with reference personal authentication data already recorded in the personal information management table (FIG. 4A) at step S12. If the received authentication data matches with any one of the personal authentication data already recorded in the personal information management table (YES determination at step S13), the controlling manager 1 transmits, to the portable terminal 10 via wireless communication, various information including an affirmative authentication result (“authentication OK” message), “personal ID” of the user, number of the “personal GUI” set by the user and number of the “startup tones” registered by the user, at step S14. If, on the other hand, the received authentication data fails to match with any one of the already-recorded personal authentication data (NO determination at step S13), the controlling manager 1 transmits a negative authentication result (“authentication NG” message) to the portable terminal 10, at step S15.

The portable terminal 10 then receives the authentication result information and, if the authentication result is affirmative (“OK”) (i.e., if a YES determination is made at step S4), starts up an operation program of the terminal 10 using the received “personal GUI” and “startup tones” and also stores the information that the terminal 10 is being used by the user of the received “personal ID”.

If, on the other hand, the authentication result is negative (“NG”) (i.e., if a NO determination is made at step S4), an operation program of the portable terminal 10 is started up using a GUI for a guest prestored in the terminal 10 and also stores the information that the terminal 10 is being used by a guest, at step S6. Then, the user can perform a re-authentication process or new-registration process, at step S7. In this way, the portable terminal 10 can identify the user currently using the terminal 10 and operate using setting information corresponding to the user.

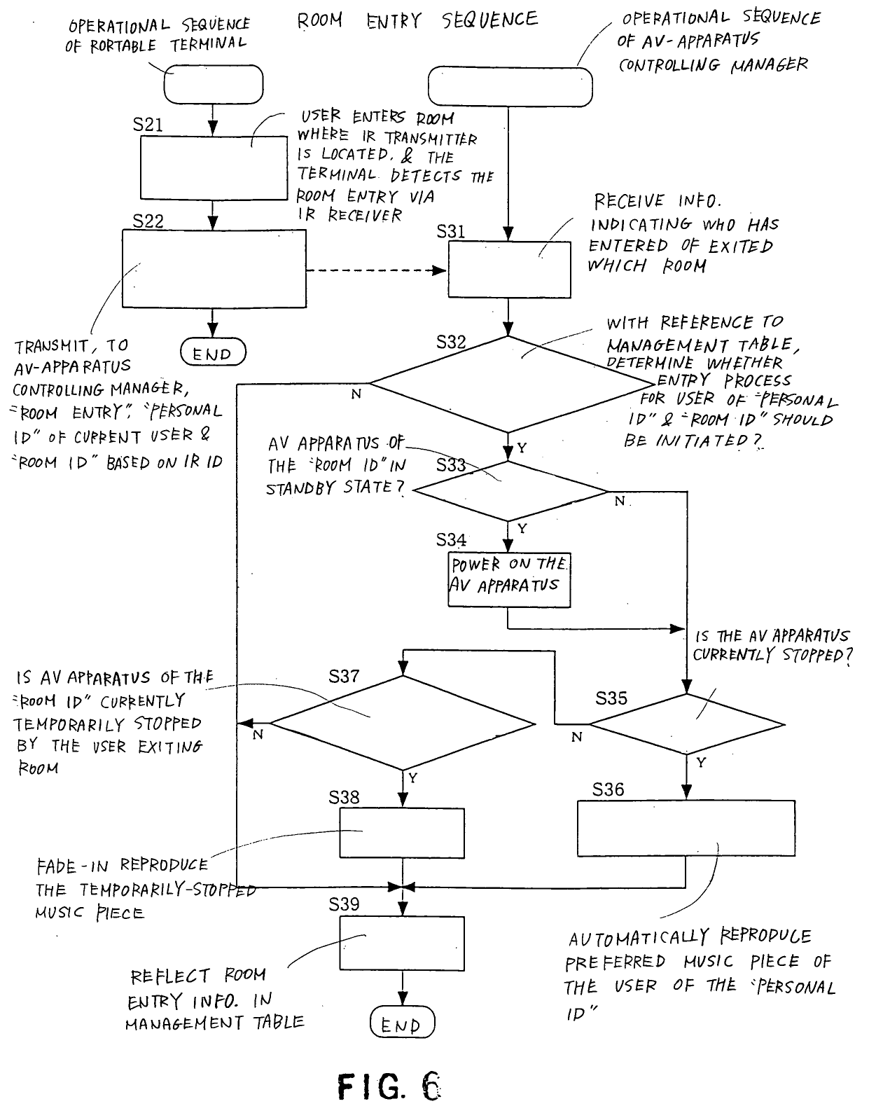

FIG. 6 is a flow chart showing an example operational sequence of a room entry process (“room entry sequence”) carried out as any one of the users holding the portable terminal 10, who has duly undergone the personal authentication, enters one of the rooms.

Once the user enters the room, having the IR transmitter 6-8 located therein, with the portable terminal 10, the position detection section 12, built in the portable terminal 10, receives an infrared signal from the IR transmitter 6-8 of the room to detect which of the rooms the user has entered, at step S21. Then, at step S22, the portable terminal 10 transmits, to the AV-apparatus controlling manager 1, information indicative of the “room entry” (i.e., room entry information), “personal ID” indicative of the current user of the portable terminal 10, “room ID” indicative of the room detected by the position detection section 12.

Then, once the AV-apparatus controlling manager 1 receives, from the portable terminal 10, the “room entry” information, “personal ID” and “room ID” indicating which of the users has entered which of the rooms (step S31), a determination is made, at step S32, as to whether reproduction of a music piece preferred by the user should be automatically initiated, with reference to the “entry process” item in the management table of FIG. 4C which designates a process to be performed when the user has entered that room. If reproduction of any user-preferred music piece should not be initiated as determined at step S32, the process of FIG. 6 goes to step S39, where the information that the user has entered the room is reflected in the AV apparatus information management table.

If reproduction of a music piece preferred by the user should be automatically initiated as determined at step S32, a further determination is made, at step S33, as to whether the AV apparatus in the room is currently in a standby (i.e., power-OFF) state, with reference to the AV apparatus information management table. If answered in the affirmative at step S33, the AV apparatus is powered on at step S34, but, if answered in the negative (i.e., the AV apparatus is currently ON), the process branched directly to step S35.

At step S35, it is further determined whether the AV apparatus in the room is currently in a stopped (non-operating) state. If the AV apparatus is currently in the stopped state as determined at step S35, a music piece preferred by the user, stored in the AV apparatus information management table, is automatically reproduced at step S36, after which the process of FIG. 6 proceeds to step S39. If the AV apparatus is not currently in the stopped state (NO determination at step S35), a determination is made, at step S37, as to whether the AV apparatus in the room is currently placed in a temporarily-stopped or interrupted (or paused) state by the user exiting the room. If answered in the negative at step S37 (e.g., when music piece reproduction by the AV apparatus is in progress or when the AV apparatus is currently placed in the temporarily-stopped or interrupted state by operation of the user), the process branches directly to step S39, where the current “room entry” information is reflected in the AV apparatus information management table. If, on the other hand, the AV apparatus in the room is currently placed in the temporarily-stopped state due to detection of the user exiting the room (YES determination at step S37), the music piece that has been in the temporarily-stopped state so far is reproduced in a fade-in manner (i.e., while being subjected to a fade-in operation) at step S38, after which the process of FIG. 6 proceeds to step S39 to reflect the current room entry information in the AV apparatus information management table.

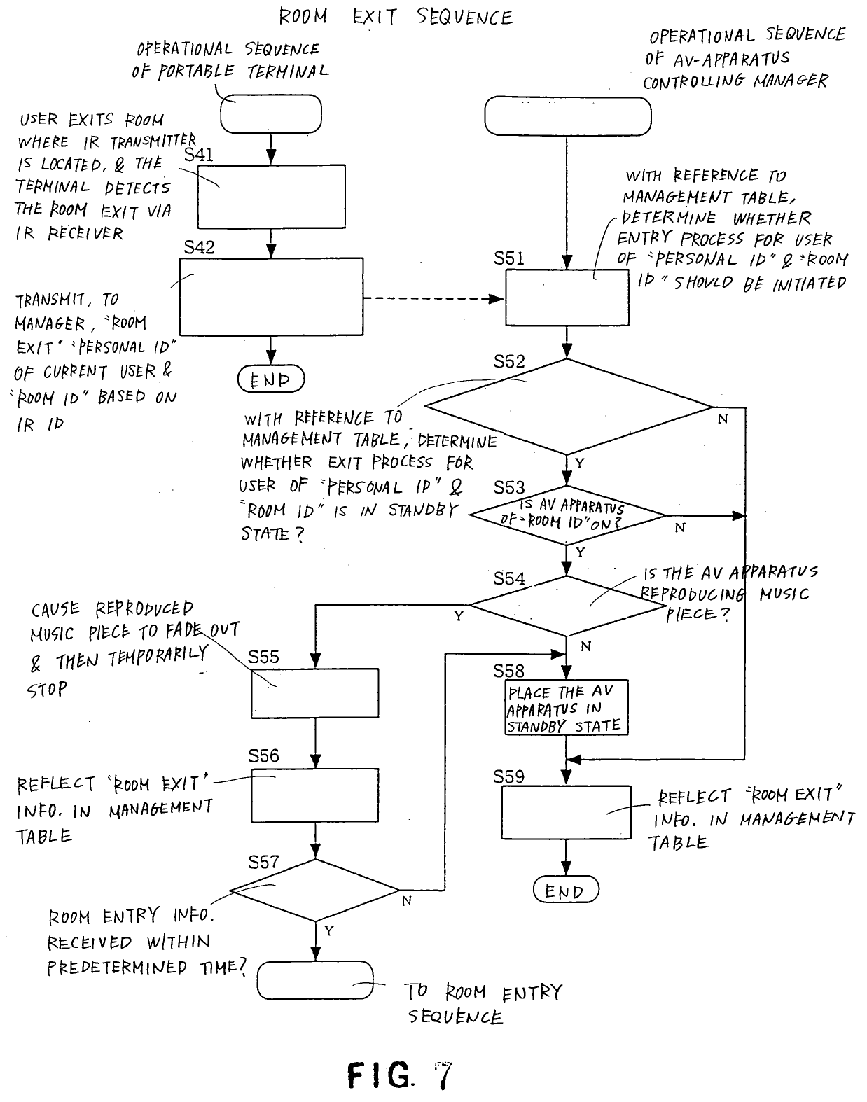

FIG. 7 is a flow chart showing an example operational sequence of a room exit process (“room exit sequence”) carried out as any one of the users holding the portable terminal 10 exits one of the rooms.

Once the user exists the room with the portable terminal 10, the position detection section 12, built in the portable terminal 10, can no longer receive an infrared signal from the IR transmitter 6-8 of the room and thus detects that the user has exited the room, at step S41. Then, at step S42, the portable terminal 10 transmits, to the AV-apparatus controlling manager 1, information indicative of the “room exit”(i.e., room exit information), “personal ID” indicative of the current user of the portable terminal 10, “room ID” indicative of the room where the user has stayed so far.

Then, once the AV-apparatus controlling manager 1 receives, from the portable terminal 10, the “room exit” information, “personal-ID” and “room ID” indicating which of the users has exited which of the rooms (step S51), a determination is made, at step S52, as to whether an exit process is currently set in a standby state, with reference to the corresponding “user” and “exit process” items in the AV-apparatus-control and entry/exit-process management table of FIG. 4C. If the exit process is in other than the standby state as determined at step S52, the process of FIG. 6 goes to step S59, where the current “room exit” information is reflected in the AV apparatus information management table. If, on the other hand, the exit process is in the standby state, it is further determined, at step S53, whether the power supply to the AV apparatus of the room, where the user has stayed so far, is currently in the ON state. If the power supply to the AV apparatus is not ON (i.e., if the AV apparatus in the power-OFF state), the process of FIG. 6 goes to step S59 to update the AV apparatus information stored in the management table. If, on the other hand, the power supply to the AV apparatus is ON (i.e., if the AV apparatus in the power-ON state) as determined at step S53, a further determination is made, at step S54, as to whether the AV apparatus is currently in the process of reproducing a music piece.

If the AV apparatus of the room, which the user has exited, is currently in the process of reproducing a music piece as determined at step S54, the currently-reproduced music piece is caused to fade out and placed in the temporarily-stopped state at step S55, and the information that the user has exited the room is stored, at step S56, in the AV-apparatus information management table.

After that, a further determination is made, at step S57, as to whether room entry information has been received from the portable terminal 10 within a predetermined time period (e.g., five minutes). If the predetermined time period has elapsed without any person entering the room, a NO determination is made at step S57, and the process of FIG. 7 branches to step S58 in order to transmit a control signal to the AV apparatus of that room to place the AV apparatus in the standby state. Then, the process proceeds to step S59; note that step S59 may be skipped.

If, on the other hand, room entry information, indicating that any one of the users has entered the room, has been received from the portable terminal 10 within the predetermined time period, then the process of FIG. 7 shifts to the room entry sequence described above and shown in FIG. 6. If it is determined, on the basis of the “personal ID” received form the portable terminal 10, that the user having now entered the room is identical to the user having exited the room immediately before, then a YES determination is made at step S37 of FIG. 6, so that the music piece that has been in the temporarily-stopped state so far is reproduced in a fade-in manner at step S38 of FIG. 6.

Namely, the instant embodiment is constructed in such a manner that, by the user only entering the room where the AV apparatus is located, the AV apparatus of the room can be automatically powered on to start reproducing the user's preferred music piece. Further, as the user exits the room where the AV apparatus is located, the AV apparatus of the room can be automatically placed in the standby state, and, if any music piece is being reproduced, reproduction of that music piece can be brought to the interrupted or temporarily-stopped state. Furthermore, as the user re-enters the same room within the predetermined time period, the reproduction of the music piece that has so far been in the temporarily-stopped state can be resumed automatically.

Therefore, it is not necessary for the user to perform particular operation for powering on/off the AV apparatus, and thus, even if the user forgets to power off the AV apparatus, wasteful power consumption can be avoided. Further, through the fade-in and fade-out operations, the embodiment can temporarily stop reproduction of a music piece and can resume temporarily-stopped reproduction of a music piece in an auditorily-natural manner.

[Embodiment 2]

Now, a second embodiment of the present invention will be described. In the second embodiment, the AV apparatus are constructed as client apparatus, each of which is arranged to receive, from a server apparatus storing a plurality of sets of music piece data, a set of music piece data to reproduce the music piece. In the above-described first embodiment where each of the AV apparatus possesses content (music data) to be reproduced, the content that can be reproduced by the individual AV apparatus differ among one another, so that interrupting/resuming of music piece reproduction can not be executed across a plurality of rooms, although the interrupting/resuming is permitted within a same room. By contrast, in the second embodiment where all items of content are managed collectively by the AV-apparatus controlling manager, all of the AV apparatus can reproduce the same content, and interrupting/resuming of music piece reproduction is permitted across a plurality of rooms.

In the second embodiment, the AV-apparatus controlling manager 1 also manages items of content (music piece data) to be reproduced by the plurality of AV apparatus 3-5 as the client apparatus. The AV-apparatus controlling manager 1 includes, in addition to the components shown in FIG. 3, a music piece data storage section storing sets of music piece data representative of a plurality of music pieces. The AV apparatus 3-5 in the second embodiment do not possess content to be reproduced and are arranged to reproduce music piece data stream-distributed from the AV-apparatus controlling manager 1. Let it be assumed here that one AV apparatus is located in each of the rooms.

Further, the AV-apparatus controlling manager 1 monitors the number of streams being simultaneously reproduced, so as to perform control, for each music piece limited in the number of permissible simultaneous reproduction, to inhibit (i.e., not permit) reproduction in more than a predetermined number of rooms.

As management data, the AV-apparatus controlling manager 1 stores a personal information management table similar to that of FIG. 4A, an AV-apparatus-control and entry/exit-process management table similar to that of FIG. 4C, and an AV-apparatus management table and user management table as shown in FIGS. 8A and 8B. Note that the AV-apparatus-control and entry/exit-process management table may be dispensed with if a separate process does not have to be set for each of the rooms and for each of the individual persons.

FIG. 8A shows an example of the AV-apparatus management table recording information as to what the AV apparatus located in each of the rooms is doing. As shown, in the AV-apparatus management table, there are stored, for each of the rooms i.e. for each of the AV apparatus, current states of the room or AV apparatus, information identifying a music piece that is currently reproduced or was being reproduced (in the illustrated example, name of an album and place, of the music piece, in the album), a reproducing position of the music piece (elapsed time from the beginning of the music piece), and a reproduction mode (repeat reproduction or random reproduction mode).

FIG. 8B shows an example of the user management table recording information as to which music piece each of the users is reproducing and in which of the rooms. As shown, in the user management table, there are stored, for each of the rooms, various information, such as a current position of the user, states of the AV apparatus in the room where the user is currently in or was in immediately before the current time, information identifying the music piece, a reproducing position of the music piece and reproduction mode.

Each of the above-mentioned management tables is updated with information received from the individual AV apparatus and portable terminals on a periodical basis or whenever a change has occurred in their states.

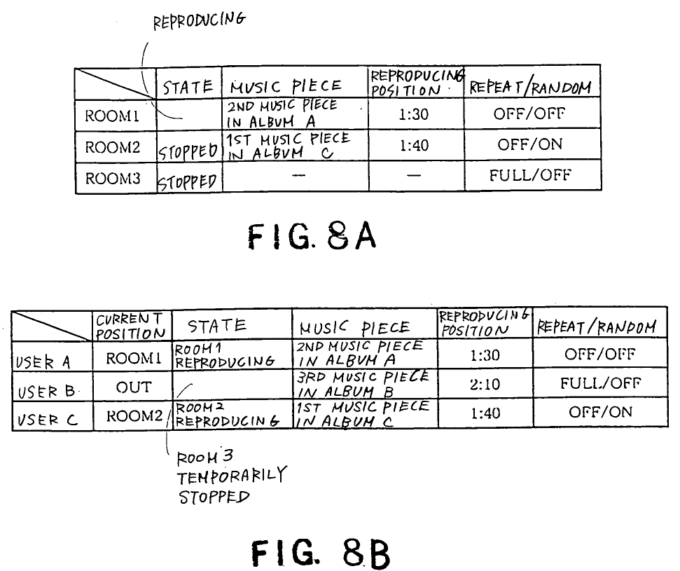

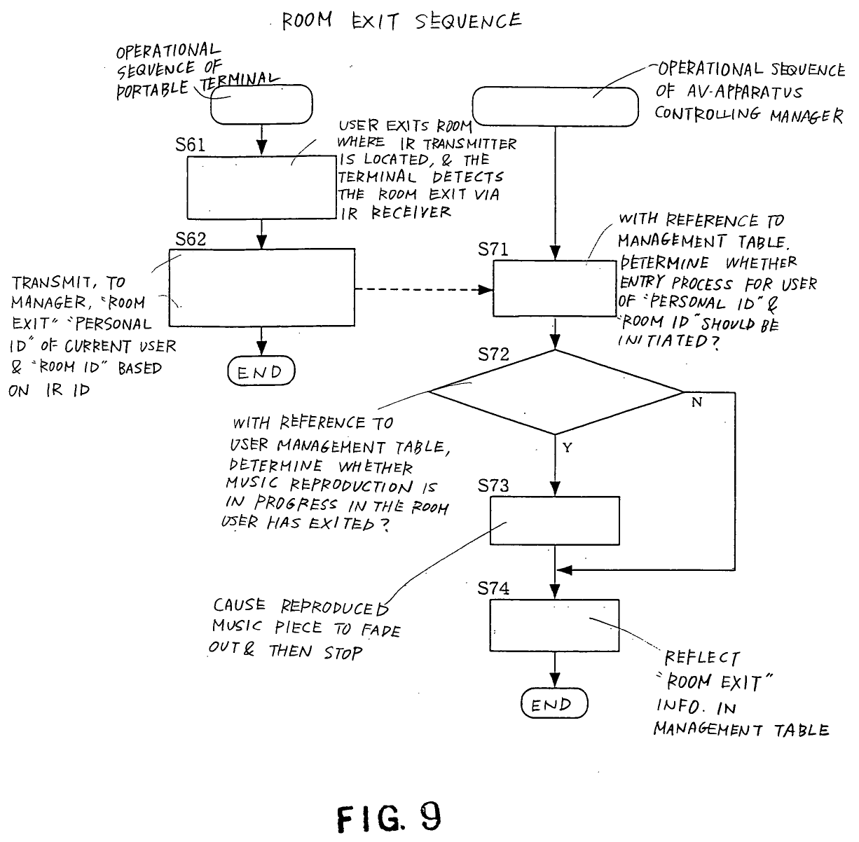

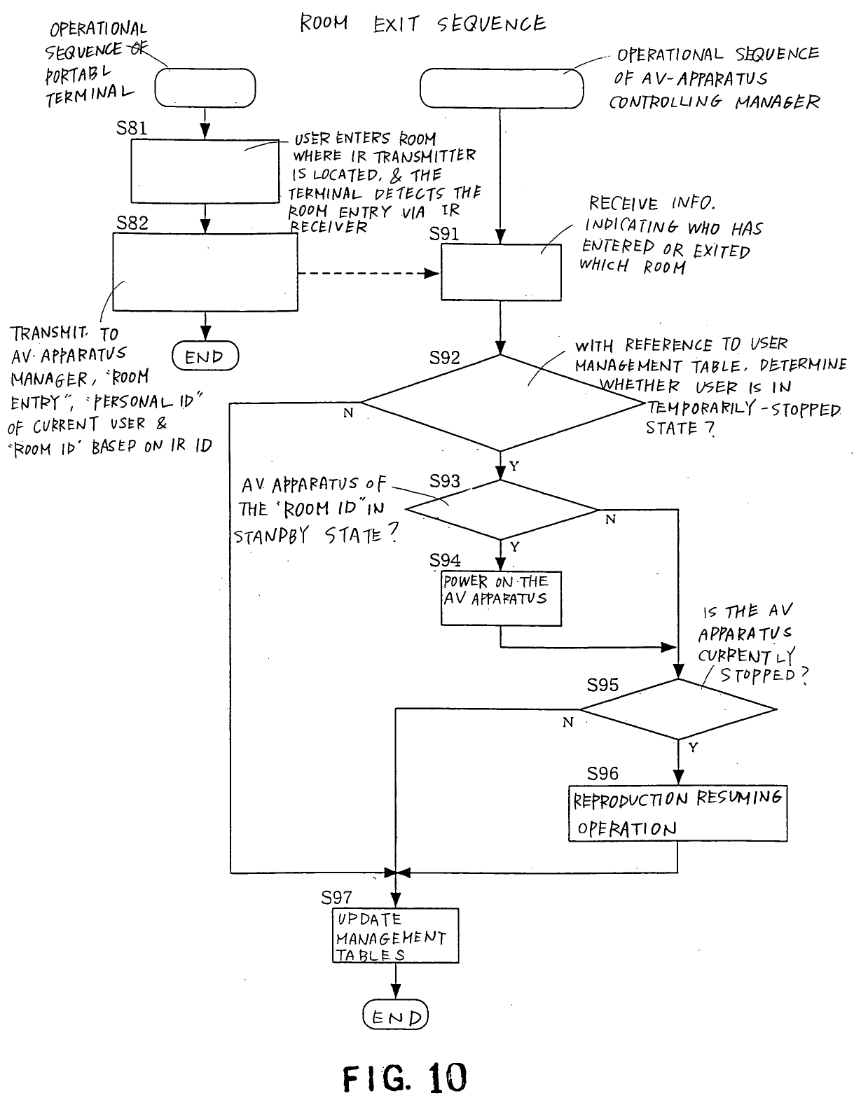

A description will be made about behavior of the thus-arranged second embodiment when any one of the users has moved from one room to another, with reference to FIGS. 9 and 10 showing a room entry sequence and room exit sequence, respectively. Let it be assumed here that the personal authentication has already been completed through the same procedures as shown in FIG. 5. Also, for simplification of description, let it be assumed that, for each of the users, the room entry/exit processes are set to “perform no operation in any of the rooms and that reproduction of a music piece is brought directly to the stopped state without taking the temporarily-stopped state.

In the room entry process (sequence) of FIG. 9, once it is detected, in the same manner as shown in FIG. 7, that any one of the user has exited one of the rooms, the portable terminal 10 transmits, to the AV-apparatus controlling manager 1, information indicative of the “room exit”, “personal ID” indicative of the current user of the portable terminal 10, “room ID” indicative of the room which the user has exited, at steps S61 and S62.

Then, once the AV-apparatus controlling manager 1 receives the above-mentioned information from the portable terminal 10 at step S71, the process of FIG. 9 goes to step S72, where a determination is made, with reference to the user management table of FIG. 8B, as to whether reproduction of a music piece is in progress in the room the user has exited. If answered in the negative at step S72, the information that the user has exited the room is reflected in the user management table, at step S74.

If, on the other hand, reproduction of a music piece is in progress as determined at step S72, the music piece is caused to fade out and the AV apparatus of the room is brought to the stopped state, at step S73. Also, the AV apparatus management table and the user management table are updated at step S74. Namely, the current state of the room in the AV apparatus management table is set to “non-operating (or stopped)” state, the current position of the user in the user management table is set to “OUT”, and the state of the user in the user management table is set to “temporarily stopped” with the room ID of the room the user has exited (i.e., previous room) attached to the user state.

The room entry process (sequence) of FIG. 10 is carried out when any of the users has entered one of the rooms. Similarly to the foregoing, once the portable terminal 10 detects, at step S81, that the user has entered the room where the IR transmitter is located, it transmits the “room entry” information, “personal ID” and “room ID” to the AV-apparatus controlling manager 1 at step S82.

Then, once the AV-apparatus controlling manager 1 receives the above-mentioned information from the portable terminal 10 at step S91, the process of FIG. 10 goes to step S92, where a determination is made, with reference to the user state stored in the user management table, as to whether the user is in the temporarily-stopped state. If the user is not in the temporarily-stopped state, the information that the user has entered the room is reflected in the user management table, at step S97. If, on the other hand, the user is in the temporarily-stopped state as determined at step S92, and if the AV apparatus of the room the user has entered is in the standby state as determined at step S93, then the AV apparatus is powered on at step S94, and a determination is made, at step S95, as to whether the. AV apparatus is in the stopped state.

If the AV apparatus is in the stopped state as determined at step S95, an operation is performed, at step S96, for resuming reproduction of a music piece that has so far been interrupted. More specifically, the AV-apparatus controlling manager 1 refers to the user management table to set the reproduction mode of the current user (i.e., repeat or random reproduction mode) in the AV apparatus of the room the user has entered, and starts reproducing the so-far-interrupted at the recorded reproducing position in a fade-in manner. Then, at following step S97, the management tables are updated.

If, on the other hand, the AV apparatus is not in the stopped state, i.e. reproducing a music piece, the AV-apparatus controlling manager 1 judges that the AV apparatus of the room is being used by someone else, and then the management tables are updated at step S97 without performing the reproduction resuming operation.

The following paragraphs describe details of the AV management table and user management table, with reference to FIGS. 11-14.

(A) Let's assume that the AV apparatus of Room 1 is currently in the standby state and User A is currently in Room 1, in which case the AV management table and user management table assume states as illustrated in FIGS. 11A and 11B. Namely, only a current apparatus state “Standby” is recorded in a storage area for Room 1 of the AV management table, and a current user position “Room 1” is recorded in a storage area for User A of the user management table.

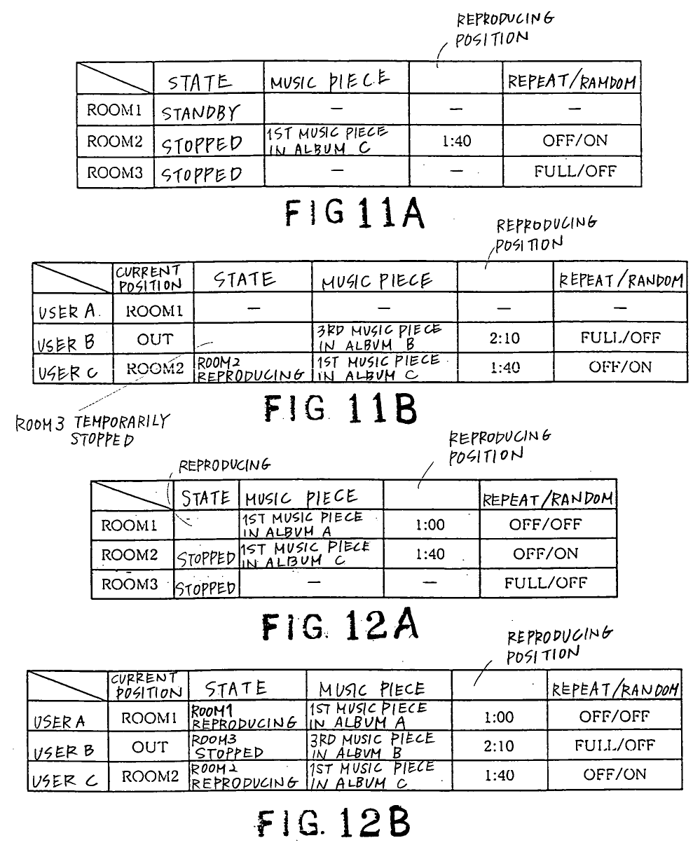

(B) Assume that User A then powers on the AV apparatus of Room 1 to initiate reproduction of album A. In this case, the AV apparatus management tables assume states as illustrated in FIGS. 12A and 12B when the AV apparatus is reproducing a “1:00” point of the first album of album A. Namely, that the “1:00” point of the first album of album A is currently being reproduced is recorded in a storage area for Room 1 of the AV management table, and that the repeat reproduction and random reproduction are each “OFF” is recorded in a storage area for User A of the user management table.

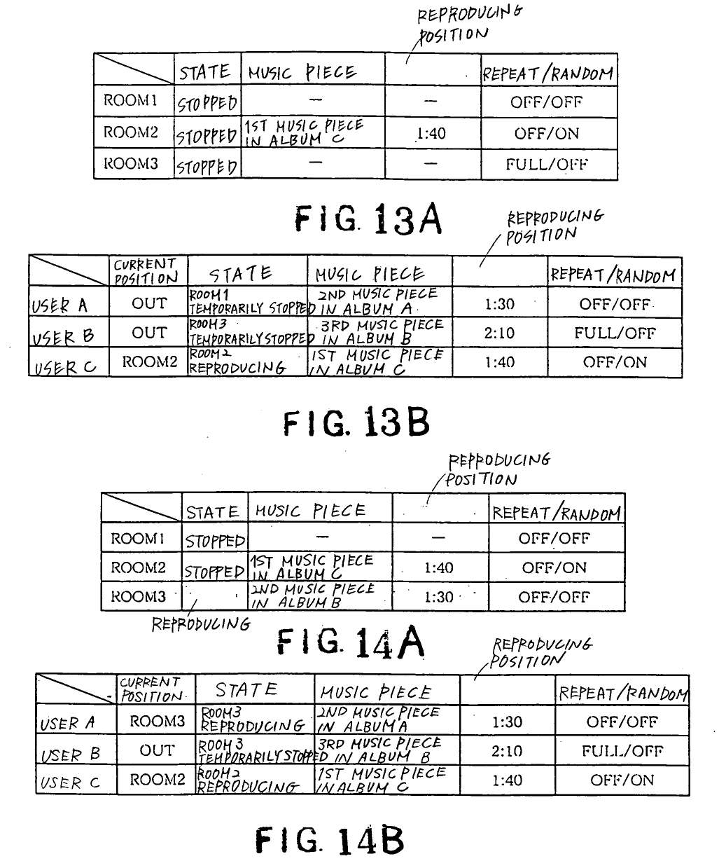

(C) Assume that User A then exits Room 1 at a “1:30” point of the second album of album A and moves to a place other than the rooms. Once the AV-apparatus controlling manager 1 recognizes that User A has exited Room 1, it stops the music piece reproduction in Room 1 in a fade-out fashion as set forth above in relation to the room exist process of FIG. 9, and it updates the management tables as illustrated in FIGS. 13A and 13B. Namely, a current state “Stopped” is recorded in a storage area for Room 1 of the AV management table, and a current user position “Out” and current user state “Room 1 and temporarily stopped” are recorded in a storage area for User A of the user management table.

(D) Assume that User A then enters Room 3. In this case, as set forth above in relation to the room entry process of FIG. 10, the AV-apparatus controlling manager 1 ascertains, with reference to the user management table, that User A was reproducing a music piece in Room 1 a while ago and no music piece reproduction is currently performed in Room 3, after which the controlling manager 1 decides to resume a continuation of the reproduction that was being executed in Room 1 and performs a reproduction resuming operation. Then, the repeat/random reproduction in Room 3 is set to the same ON/OFF setting as in Room 1. After that, the AV-apparatus controlling manager 1 starts reproducing the second music piece in Album A at the “1:30” point in a fade-in fashion. Thus, the management tables are updated as illustrated in FIGS. 14A and 14B.

Note that, if any music piece is being reproduced in Room 3 in phase (C) above, the AV-apparatus controlling manager 1 judges that someone else is currently using Room 3 and thus does not perform the reproduction resuming operation.

When the music piece, which has been temporarily stopped after user's exit from the previous room, is to be reproduced in a fade-in fashion in another room the user has entered, the instant embodiment permits the desired music piece reproduction with enhanced auditory naturalness without involving a blank time period of the music piece reproduction, by setting a normal-reproduction-level returning time point, at which the reproduction should return to a normal reproduction level, to such a point that precedes an attenuation start time point at which the music piece was caused to start fading out in the previous room. For example, where the interruption point (i.e., temporarily-stopping point) is “1:30 (one min. and thirty sec.)” as in the example illustrated in FIG. 13 or 14, the reproduction in Room 3 is controlled in such a manner that the normal-reproduction-level returning point can be set to a “1:27 (one min. and thirty sec.)” point preceding the interruption point.

Further, by variably setting parameters for the fade-in and fade-out operations in accordance with a moving speed of the user and genre of the music piece, the music piece reproduction in the other (or newly-moved-to) room can secure auditorily-natural continuity from the reproduction in the previous room. Note that the above-described first embodiment may also be subjected to the fade-in/fade-out control employed in relation to the second embodiment.

Namely, the instant embodiment can automatically interrupt or temporarily stop music piece reproduction in response to user's exit from a room, and allows the reproduction in the previous room to be taken over to another room in response to entry, of the user, into the other room without involving a blank time period of the music piece reproduction; at that time, not only the music piece but also the same reproduction mode as in the previous room is used in the other (or newly-moved-to) room. Note that, when the user has re-entered the same room, reproduction of the so-far-temporarily-stopped music piece reproduction is also automatically resumed in the manner as set forth above.

Further, the instant embodiment is arranged to perform the fade-out operation in response to user's room exit and the fade-in operation in response to user's room entry. With such arrangements, the embodiment can provide natural auditory feelings. In addition, by setting the fade-in ending time point to precede the fade-out starting time, the instant embodiment allows music piece reproduction across two rooms to be imparted with even further natural continuity.

Furthermore, even for a music piece limited in the number of permissible simultaneous reproduction, the second embodiment automatically interrupts reproduction of the music piece in response to user's exit from one room and automatically resumes the reproduction in another room in response to entry, of the user, into the other room; thus, the right to reproduce the music piece can be automatically taken over from the one (i.e., previous) room to the other (i.e., newly-moved-to) room without the music piece being simultaneously reproduced in the two rooms.

[Embodiment 3]

Now, a third embodiment of the present invention will be described. Whereas the first and second embodiments have been described as employing the portable terminal 10 that includes the personal authentication section, such as a fingerprint sensor, and position detection section and that communicates with the AV-apparatus controlling manager 1, the third embodiment employs one or more remote controllers each having an infrared transmission function for controlling the AV apparatus, similarly to the conventional AV system. Further, in the third embodiment, no fingerprint sensor is employed for the personal authentication purpose; instead, information identifying a user is transmitted from the remote controller to the AV apparatus so that the AV apparatus can transmit the “personal ID” of the user and room entry/exit information to the AV-apparatus controlling manager 1. Namely, in the third embodiment, there is no need to employ any particular device that includes a fingerprint sensor and position detection section, although the user is required to perform predetermined minimum necessary operation.

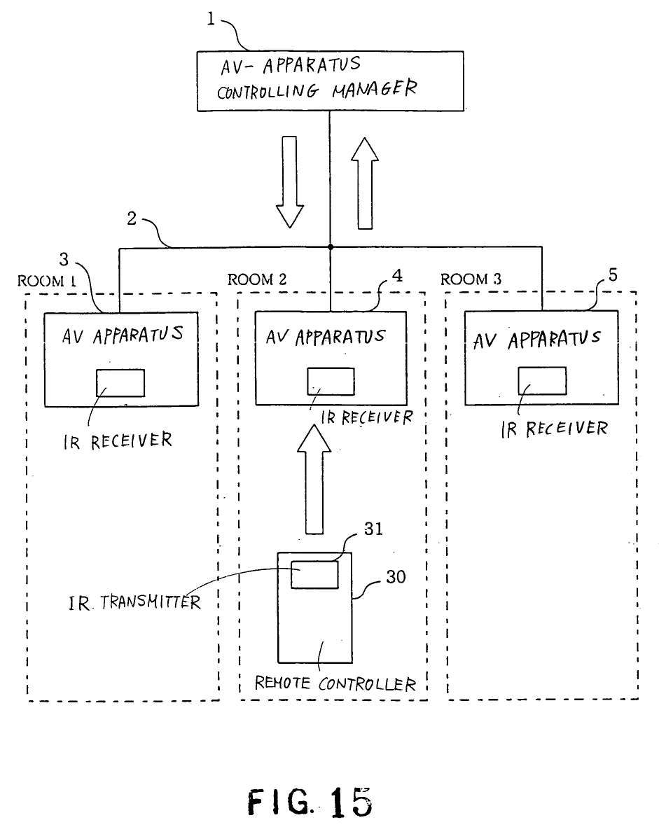

FIG. 15 is a block diagram showing an example general setup of the third embodiment of the present invention. In the figure, the same elements as in FIG. 1 are represented by the same reference numerals as in FIG. 1 and will not be described here to avoid unnecessary duplication. Let it be assumed that, in the third embodiment too, one AV apparatus is located in each of the rooms and the AV apparatus in such a manner that the rooms correspond to each other on a one-to-one basis.

In FIG. 15, reference numeral 30 represents the remote controller for controlling the AV apparatus 3-5, which has an infrared transmission section (IR transmitter) 31 built therein. The remote controller 30 also includes a means for allowing the user to transmit his or her personal ID, and a means for informing user's entry or exit into or from any one of the room.

The above-mentioned means for allowing the user to transmit his or her personal ID may be implemented either by (1) fixedly assigning in advance the personal ID of one user to each of the remote controllers and causing each user to use his or her own remote controller, or (2) providing each of the remote controllers with user selection switches and causing each user to select his or her ID via the user selection switches. In the instant embodiment, each of the remote controllers is arranged to transmit, to the AV apparatus, a control signal along with the personal ID of the user, so that the AV apparatus can identify the user through the personal ID.

Further, the above-mentioned means for informing user's entry or exit into or from any one of the room may be implemented by either (1) providing “Room Entry” and “Room Exit” buttons on each of the remote controllers 30 and causing the user to operate the corresponding one of the “room entry”. and “room exit” buttons when the user enters or exits any one of the rooms, or (2) causing the user to operate an “ON/Standby” button when the user enters or exits any one of the rooms.

According to approach (1) above, once the user operates the “room entry” button, a code indicative of the room entry and personal ID of the user are transmitted from the IR transmission section 31 to the AV apparatus. The AV apparatus, having received the “room entry” code, transmits, to the AV-apparatus controlling manager 1 via the communication network 2, the “personal ID”, “room entry” information and “apparatus ID (i.e., room ID)” of the AV apparatus. Similarly, when a “room exit” code has been received, the AV apparatus transmits, to the AV-apparatus controlling manager 1, the “personal ID”, “room exit” information and “apparatus ID (i.e., room ID)” of the apparatus.

In approach (2) above, the “ON/Standby” button is a button switch, similar to those provided on the conventional remote controllers, for switching between power-ON and standby states of the AV apparatus. When a remote controller code “ON/Standby” has been received during the standby state, the AV apparatus judges that the user has entered the room, but, when a remote controller code “ON/Standby” has been received during the power-ON state, the AV apparatus judges that the user has exited the room. Then, in the same manner as in approach (1), the AV apparatus transmits, to the AV-apparatus controlling manager 1, the “room entry/exit” information, “personal ID” and “apparatus ID (i.e., room ID)” of the apparatus.

Namely, once any one of the AV apparatus 3-5 detects entry or exit, of the user, into or from the corresponding room, the room entry or exit information is transmitted via the communication network 2 to the AV-apparatus controlling manager 1, in response to which the controlling manager 1 performs operations similar to those performed in the above-described first or second embodiment.

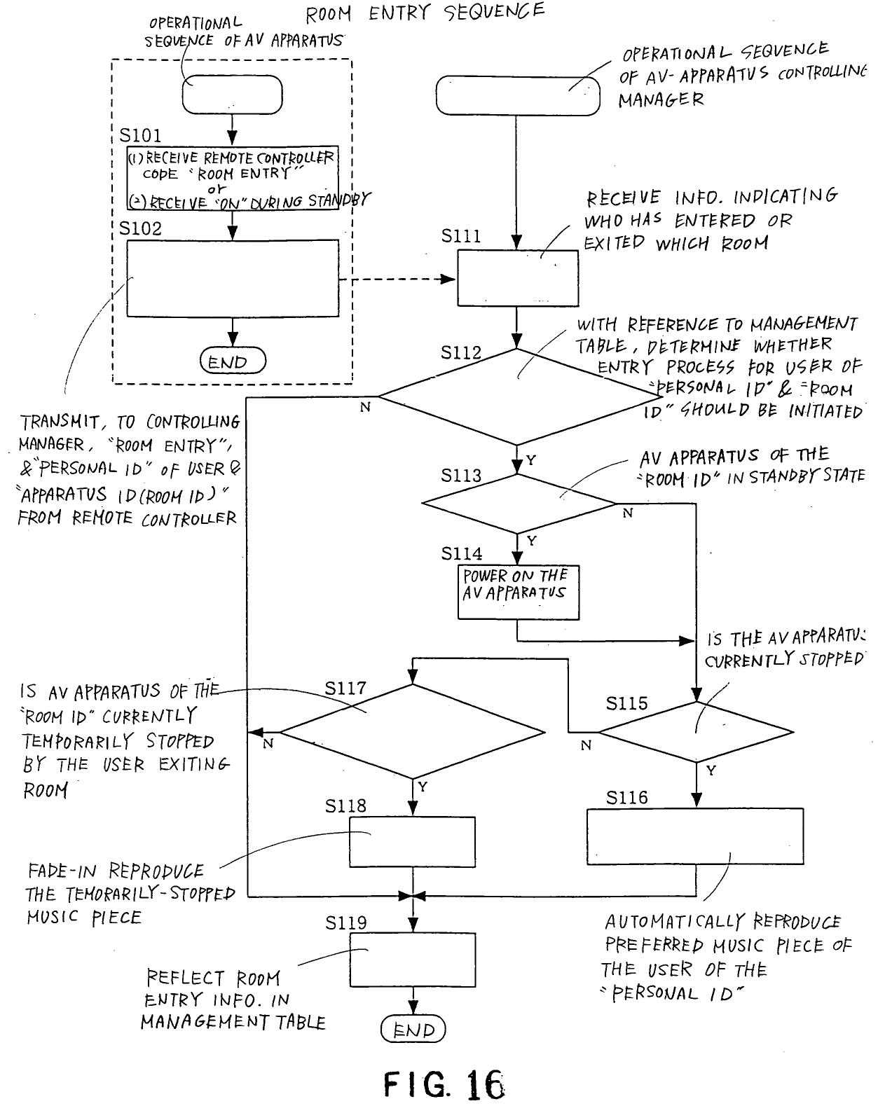

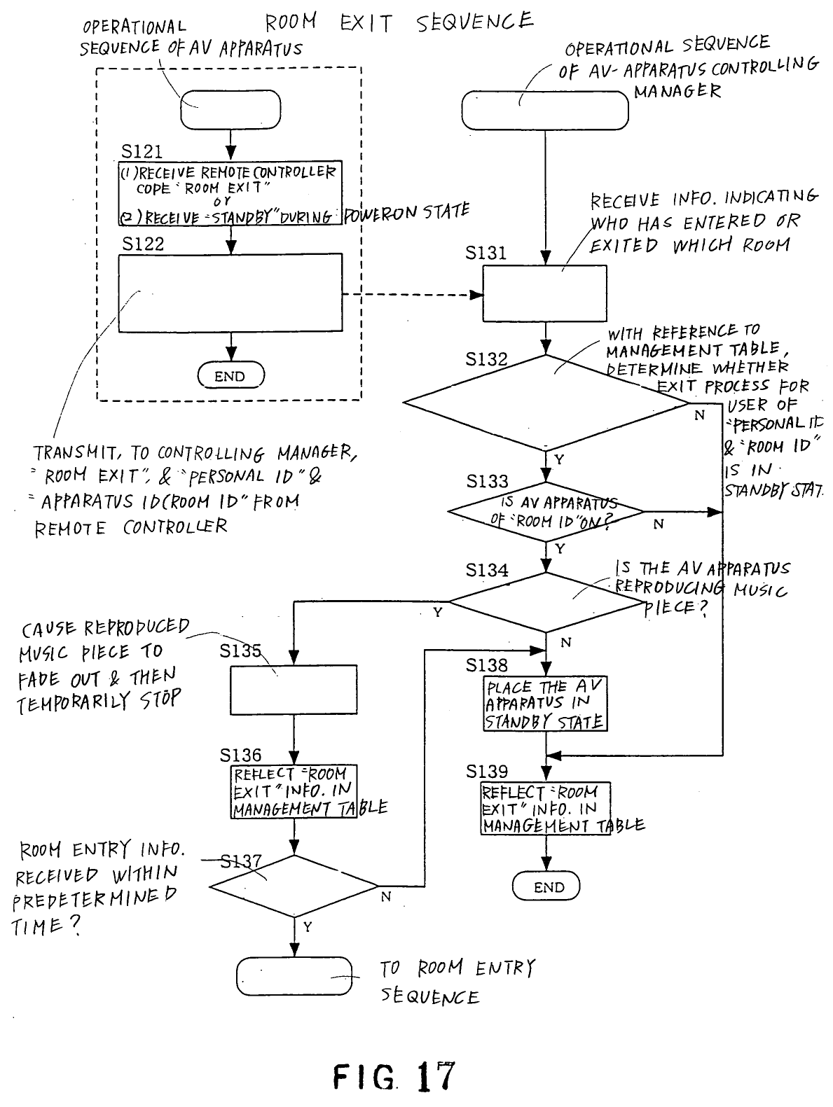

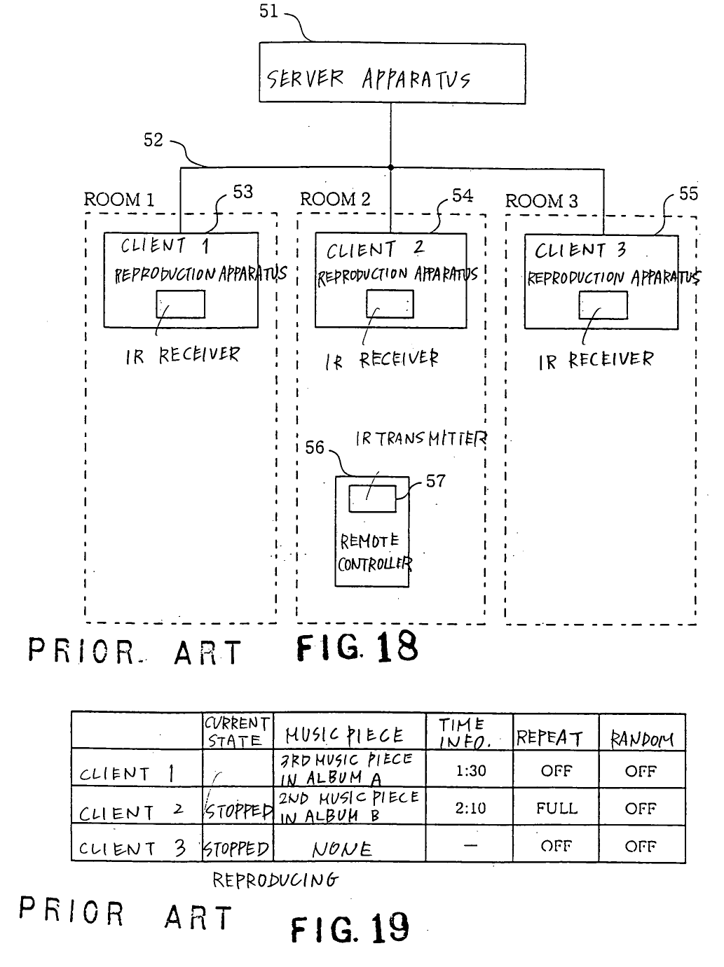

FIGS. 16 and 17 are flow charts showing example operational sequences of a room entry process and room exit process, respectively, carried out in the third embodiment using the remote controller 30 in place of the portable terminal 10.

The room entry process of FIG. 16 is different from the room entry process of the first embodiment (FIG. 6) in that the “room entry” information, “personal ID” and “room ID” are transmitted from the AV apparatus to the AV-apparatus controlling manager 1, as indicated in a portion (steps S101 and S102) of FIG. 16 enclosed by dotted lines.

Further, the room exit process of FIG. 17 is different from the room exit process of the first embodiment (FIG. 6) in that the “room exit” information, “personal ID” and “room ID” are transmitted from the AV apparatus to the AV-apparatus controlling manager 1, as indicated in a portion (steps S121 and S122) of FIG. 17 enclosed by dotted lines.

Namely, the third embodiment, using the remote controller 30 having the function of transmitting the user's personal ID, can perform operations similar to those performed in the first embodiment employing the portable terminal 10.

Further, in the case where the AV apparatus are client apparatus each receiving a set of music piece data, from the server storing a plurality of sets of music piece data, to audibly reproduce the music piece, the third embodiment can perform operations similar to those performed in the second embodiment, by causing the personal ID and room entry or exit information of the user to be transmitted from the AV apparatus to the AV-apparatus controlling manager 1. In this case, it is just necessary that steps S61 and S62 in the room exit process of FIG. 9 be replaced with steps S121 and S122 of FIG. 17 that are executed by the AV apparatus, and that steps S81 and S82 in the room entry process of FIG. 10 be replaced with steps S101 and S102 of FIG. 16.

Namely, using the remote controller 30 having the IR transmission function, the third embodiment can perform operations similar to those performed in the first and second embodiments, by only causing the user to perform minimum necessary operation.

Note that, whereas each of the embodiments of the present invention has been described in relation to temporary stop (interruption or pause) and resumption of audio data reproduction, the basic principles of the invention are also applicable to cases where visual or video information is stream-distributed.

1. An Audio/Video system, comprising:
an Audio/Video apparatus;
an Audio/Video-apparatus management apparatus that controls said Audio/Video apparatus and includes a section that stores personal information and position information of each user; and
a portable terminal that includes a personal authentication section and a position detection section,
wherein, on the basis of personal authentication information and position detection information transmitted by said portable terminal, said Audio/Video-apparatus management apparatus turns on power to said Audio/Video apparatus located in a room upon detecting that the user has entered the room, while placing said Audio/Video apparatus located in the room in a standby state upon detecting that the user has exited the room.

2. An Audio/Video system, comprising:
an Audio/Video apparatus;
an Audio/Video-apparatus management apparatus that controls said Audio/Video apparatus and includes a section that stores personal information and position information of each user; and
a portable terminal that includes a personal authentication section and a position detection section,
wherein, on the basis of personal authentication information and position detection information transmitted by said portable terminal, said Audio/Video-apparatus management apparatus turning on power to said Audio/Video apparatus located in a room upon detecting that the user has entered the room and causing said Audio/Video apparatus in the room to reproduce a music piece corresponding to the user, and
upon detecting that the user has exited the room while said Audio/Video apparatus located in the room is reproducing the music piece, places reproduction of the music piece in a temporarily stopped state and places said Audio/Video apparatus located in the room in a standby state when the temporarily stopped state has lasted for a predetermined time.

3. The Audio/Video system as claimed in claim 2 wherein, upon detecting that the user has re-entered a room while said Audio/Video apparatus located in the room is in the temporarily stopped state, said Audio/Video-apparatus management apparatus causes said Audio/Video apparatus in the room to resume reproduction of the music piece that is in the temporarily stopped state.

4. The Audio/Video system as claimed in claim 2 wherein, when the reproduction of the music piece is placed in the temporarily stopped state in response to detection of the user exiting the room, said Audio/Video-apparatus management apparatus performs a fade-out operation on the music piece and then places said Audio/Video apparatus of the room in the standby state.

5. The Audio/Video system as claimed in claim 2 wherein, when the reproduction of the music piece corresponding to the user is to be initiated in response to detection of the user entering the room, said Audio/Video-apparatus management apparatus performs a fade-in operation on the music piece.

6. An Audio/Video system, comprising:
an Audio/Video apparatus that includes a section that reproduces music piece data;
an Audio/Video-apparatus management apparatus that controls said Audio/Video apparatus and includes a section that stores a plurality of sets of music piece data, and a section that stores personal information and position information of each user, the Audio/Video-apparatus management apparatus supplying a music piece to said Audio/Video apparatus; and
a portable terminal that includes a personal authentication section and a position detection section,
wherein, on the basis of personal authentication information and position detection information provided by said portable terminal, said Audio/Video-apparatus management apparatus performs, upon detecting that the user has exited one room, a fade-out operation on the music piece being currently reproduced in the one room to stop reproduction of the music piece in the one room, and upon detecting that the user has entered a second room, causes said Audio/Video apparatus in the second room to resume the reproduction of the music piece by performing a fade-in operation on the music piece in the second room.

7. The Audio/Video system as claimed in claim 6, wherein a time point at which the reproduction of the music piece should return to a normal reproduction level in the fade-in operation is set at a given time point that precedes an attenuation start time point in the fade-out operation.

8. The Audio/Video system as claimed in claim 7, wherein parameters for the fade-in and fade-out operations are variably set in accordance with a moving speed of the user and genre of the music piece, so as to secure auditorily-natural continuity of the reproduced music piece.

9. The Audio/Video system as claimed in claim 6, wherein, when the music piece is one that is limited in a number of permissible simultaneous reproductions, a right to reproduce the music piece is transferred from the one room which the user exited over to the second room which the user has entered.

10. The Audio/Video system as claimed in claim 1, wherein said portable terminal includes:
said personal authentication section including a fingerprint sensor that acquires user-authentication-related information;
said position detection section that receives, from a transmitter, a signal identifying the room where said Audio/Video apparatus is located; and
a section that transmits, to said Audio/Video-apparatus management apparatus, personal authentication information acquired by said personal authentication section and position detection information acquired by said position detection section.

11. The Audio/Video system as claimed in claim 1, wherein said portable terminal includes a section that sets a personal ID of the user; an operation button operable when the user has entered or exited the room where said Audio/Video apparatus is located, and a section that transmits, to said Audio/Video apparatus information indicating that said operation button has been operated and transmitting the personal ID of the user, and
wherein the personal authentication information and the position detection information are transmitted via said Audio/Video apparatus to said Audio/Video-apparatus management apparatus.

12. A portable terminal for use in an Audio/Video system, comprising
an Audio/Video apparatus;
an Audio/Video-apparatus management apparatus including a section that stores personal information and position information of each user, said Audio/Video-apparatus management apparatus controlling said Audio/Video apparatus in response to entry or exit, to or from a room, of the user; and
said portable terminal including:
a reception section that receives a signal from an infrared transmitter provided in the room where said Audio/Video apparatus is located, the infrared transmitter transmitting a signal identifying the room;
a fingerprint sensor; and
a section that transmits, to said Audio/Video-apparatus management apparatus, user-authentication-related information acquired by said fingerprint sensor and room-related information acquired by said reception section.

13. An Audio/Video system, comprising:
an Audio/Video apparatus;
an Audio/Video-apparatus management means for controlling said Audio/Video apparatus and including a section that stores personal information and position information of each user; and
a portable terminal means including a personal authentication section and a position detection section,
wherein, on the basis of personal authentication information and position detection information transmitted by said portable terminal means, said Audio/Video-apparatus management means turns the power on to said Audio/Video apparatus located in a room upon detecting that the user has entered the room, and places said Audio/Video apparatus located in the room in a standby state upon detecting that the user has exited the room.

14. An Audio/Video system, comprising:
an Audio/Video apparatus;
an Audio/Video-apparatus management means for controlling said Audio/Video apparatus and including a section that stores personal information and position information of each user; and
a portable terminal means for including a personal authentication section and a position detection section,
wherein, on the basis of personal authentication information and position detection information transmitted by said portable terminal means, said Audio/Video-apparatus management means turns the power on to said Audio/Video apparatus located in a room upon detecting that the user has entered the room and causes said Audio/Video apparatus in the room to reproduce a music piece corresponding to the user, and
upon detecting that the user has exited the room while said Audio/Video apparatus located in the room is reproducing a music piece, places reproduction of the music piece in a temporarily stopped state and places said Audio/Video apparatus located in the room in a standby state when the temporarily stopped state has lasted for a predetermined time.

15. The Audio/Video system as claimed in claim 14 wherein, upon detecting that the user has re-entered the room while said Audio/Video apparatus located in the room is in the temporarily stopped state, said Audio/Video-apparatus management means causes said Audio/Video apparatus in the room to resume reproduction of a music piece that was placed in the temporarily stopped state.

16. The Audio/Video system as claimed in claim 14, wherein, when the reproduction of the music piece is placed in the temporarily stopped state in response to detection of the user exiting the room, said Audio/Video-apparatus management means performs a fade-out operation on the music piece and then places said Audio/Video apparatus of the room in the standby state.

17. The Audio/Video system as claimed in claim 14, wherein, when the reproduction of the music piece corresponding to the user is initiated in response to detection of the user entering the room, said Audio/Video-apparatus management means performs a fade-in operation on the music piece.

18. A method for controlling an Audio/Video apparatus, comprising
receiving personal authentication information and position detection information transmitted by a portable terminal;
powering on said Audio/Video apparatus located in a room upon detecting that the user has entered the room;
placing said Audio/Video apparatus located in the room in a standby state upon detecting that the user has exited the room.

19. A method for controlling an Audio/Video apparatus, comprising:
receiving personal authentication information and position detection information transmitted by a portable terminal
powering on said Audio/Video apparatus located in a room upon detecting that the user has entered the room causing said Audio/Video apparatus in the room to reproduce a music piece corresponding to the user; and
upon detecting that the user has exited the room while said Audio/Video apparatus located in the room is reproducing the music piece, placing reproduction of the music piece in a temporarily stopped state and placing said Audio/Video apparatus located in the room in a standby state when the temporarily stopped state has lasted for a predetermined time.

20. The method for controlling an Audio/Video (AV) apparatus as claimed in claim 19, further including, upon detecting that the user has re-entered the room while said Audio/Video apparatus located in the room is in the temporarily stopped state, causing said AV apparatus in the room to resume reproduction of a music piece that is in the temporarily stopped state.

21. The method for controlling an Audio/Video apparatus as claimed in claim 19, further including when the reproduction of the music piece is to be placed in the temporarily stopped state in response to detection of the user exiting the room, performing a fade-out operation on the music piece and placing said Audio/Video apparatus of the room in the standby state.

22. The method for controlling an Audio/Video apparatus as claimed in claim 19, further including when the reproduction of the music piece corresponding to the user is to be initiated in response to detection of the user entering the room, performing a fade-in operation on the music piece.
